(19) United States
(12) Patent Application Publication
(10) Pub. No.: US 2008/0268145 A1
(43) Pub. Date: Oct. 30, 2008

(54) Method and Device for Applying Adhesive to Corrugated Cardboard

(76) Inventors: Frank Backhaus, Herford (DE); Roman Kappeler, Muri (CH); Thomas Meyer, Hamikon (CH)

Correspondence Address: BROWDY AND NEIMARK, P.L.L.C.;624 NINTH STREET, NW, SUITE 300, WASHINGTON, DC, 20001-5303, US

(21) Appl. No.: 11/663,918

(22) PCT Filed: Sep. 27, 2004
(86) PCT No.: PCT/EP2004/010805

§ 371 Date: May 8, 2008

(51) Int. Cl. B05D 5/00; B05C 1/00

(52) U.S. Cl. 427/207.1; 118/300

(57) ABSTRACT

A device (10) for applying adhesive to the ribbed side of corrugated cardboard (16), wherein the device (10) comprises a nozzle (15) which discharges liquid adhesive while the ribbed side of the corrugated cardboard moves past at a distance (A) below the nozzle (15). The distance (A) can be adjusted in such a way that adhesive is only applied to the ribbed side in the upper region of the ribs.

### AREA OF THE INVENTION

It concerns a device for applying adhesive to the ribbed side of corrugated cardboard and a corresponding method.

### BACKGROUND OF THE INVENTION

### Prior Art

Corrugated cardboard is typically a lightweight construction (sandwich) of cardboard, liner paper and adhesive. Corrugated cardboard is defined according to the size of the corrugations (also called ribs), the corrugated layers and the quality of the liner papers.

Conventional devices for producing corrugated cardboard operate typically with a system of rollers, of which one is provided with an adhesive film. During circulation of the corrugated cardboard around this roller, the adhesive film is transferred to the ribbed side of the cardboard.

In the conventional devices for producing corrugated cardboard, problems may occur, which are partly because the size application on the ribbed side is not very precisely meterable. In this case, inter alia, situations may occur, where the quality of the corrugated cardboard is impaired by too small or too heavy an adhesive application. It is obvious that too small an adhesive application can lead to the liner paper easily detaching from the corrugated cardboard. When the adhesive application is too heavy, on the other hand, the adhesive consumption is high and too much moisture is introduced into the cardboard.

It is important in the further processing of corrugated cardboard that the moisture content lies in predetermined limits, as, from the sandwich, for example by punching, individual elements are manufactured. For punching, the sandwich must be flat and may have no irregularities caused by moisture.

Investigations have shown that the strength of the corrugated cardboard can be impaired by damage caused by the rollers of conventional devices. During circulation of the corrugated cardboard between the rollers, the upper regions of the ribs are partially crushed. Owing to this disruption of the corrugated structure, as stated, the strength can be impaired.

In particular in the case of high-quality packagings, it is also desirable that a permanently and visually pleasing packaging can be produced from corrugated cardboard.

Therefore, the object is posed of developing a corresponding method and providing a device, which allow corrugated cardboard of high quality to be produced.

Furthermore, it is regarded as an object to reduce the adhesive consumption.

### SUMMARY OF THE INVENTION

The object is achieved by a device according to claim 1 and a method according to claim 17.

In the sub-claims, further advantageous configurations of the invention are detailed.

It is regarded as an important advantage of the invention, that the adhesive quantity can be sharply reduced in comparison to conventional devices. The invention can be designed such that the adhesive consumption is about half the consumption of conventional systems.

According to the invention, it is possible to produce particularly high-quality packagings from corrugated cardboard, which are permanently and visually pleasing. Moreover, according to the invention, liner paper can be used, which is thinner than previously, as after the adhesive application, lower moisture is in the sandwich.

From an environmental view, a device according to the invention is advantageous, as it consumes less adhesive. Moreover, a closed adhesive circuit can be produced, in which adhesive only discharges at the nozzle.

According to the invention, the process stability is improved and the reproducibility becomes very much better. Moreover, a device according to the invention can be operated at greater speeds, which results in a higher throughput.

A device according to the invention can start up and stop very much more rapidly. The size application takes place in a controlled manner. Therefore, intermediate storages and further steps are dispensed with.

Moreover, the device according to the invention, depending on the embodiment, is self-cleaning.

### FIGURES

Hereinafter, further details and advantages of the invention will be described in detail with the aid of embodiments and partially with reference to the drawings. All the figures are schematic and not to scale, and corresponding structural elements are provided in the various figures with the same reference numerals, even when they in detail differently formed. In the figures:

FIG. 1 shows a first embodiment of the invention in a highly schematic view;

FIG. 2 shows a further embodiment of the invention in side view;

FIG. 3A shows a part of a further embodiment of the invention in plan view;

FIG. 3B shows a part of the embodiment according to FIG. 3A, wherein the nozzle is adjusted obliquely;

FIG. 4 shows a further embodiment of the invention in side view;

FIG. 5 shows a further embodiment of the invention in side view.

### DETAILED DESCRIPTION OF THE EMBODIMENTS

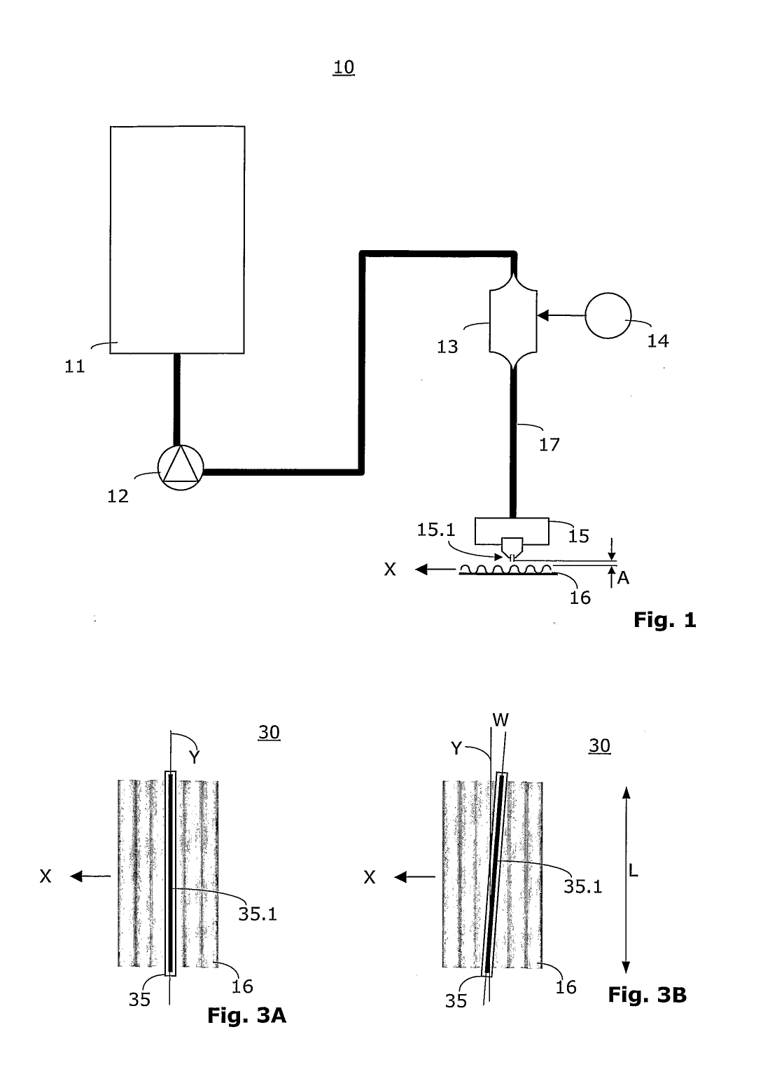

The invention relates to a device for use in the production and/or processing of corrugated cardboard. In FIG. 1, a first device 10 according to the invention is shown. The device 10 is specially designed for applying adhesive on the ribbed side of corrugated cardboard 16. The device 10 comprises a (slot) nozzle 15, which discharges liquid adhesive, while the ribbed side of the corrugated cardboard 16 is moved past at a spacing A below the nozzle 15, as indicated by the arrow X. The spacing A (with A≧0) is adjustable in such a way that only in the upper region of the ribs, adhesive is applied to the ribbed side.

Furthermore, the device 10 has an adhesive tank 11, a pump 12 and a system for through-flow measurement and regulation, which comprise preferably a through-flow regulator 13 and an actuator 14, to be able to measure the through-flow and adjust it. Through the connection 17 shown in black, adhesive is conveyed from the tank 11 into the nozzle 15. The nozzle 15 is shown in a highly schematic section. The adhesive enters on the upper side into the nozzle 15. The shown (slot) nozzle 15 has an elongated discharge opening 15.1, which faces in the direction of the corrugated cardboard 16. The elongated discharge opening 15.1, as also the ribs of the corrugated cardboard 16, extend substantially perpendicular to the plane of the drawing, wherein preferably the discharge opening 15.1 is adjusted slightly with respect to the ribs (not visible from FIG. 1).

FIG. 2 shows a further device 20 according to the invention. This device is a so-called nozzle seat, which can be used, for example, in a production line. The corrugated cardboard 16 runs as a web over two plates 28 or suitable guide elements. By springs or hydraulic means, the contact pressure of the plates 28 can be adjusted, as indicated in FIG. 2 with the aid of the double arrows 30. Above the corrugated cardboard 16 sits the actual nozzle 25. The nozzle 25 can be adjusted by means of adjusting mechanisms. By this adjustment, for example, the relative position (spacing A and/or pitch angle W) of the nozzle 25 can be predetermined with respect to the corrugated cardboard 16. Moreover, means can be provided to adjust the nozzle width or the width of the nozzle discharge opening mechanically. In FIG. 2, two wheels 27.1, 27.2 can be seen, which are connected via a belt 27.3 to one another. By driving the wheel 27.1, via a shaft or a piston, the width of the nozzle discharge opening is adjusted. There are various approaches to adjusting the width of the nozzle discharge opening. The said shaft may, for example, be mounted in a thread of the nozzle 25 in order, depending on the rotational direction, to move further in or out of a nozzle chamber. Depending on the position of the shaft, the nozzle chamber is increased or decreased and thereby also the discharge opening changed. The shaft may, however, also carry a sliding element, which is displaced by rotation of the shaft, in order to change the outlet opening. A piston may also be used in order to adjust the nozzle discharge opening.

In a preferred embodiment, the nozzle seat may be moved up and down parallel to the axis 29 in order to be able adjust the spacing A between the nozzle 25 and the ribs of the corrugated cardboard 16.

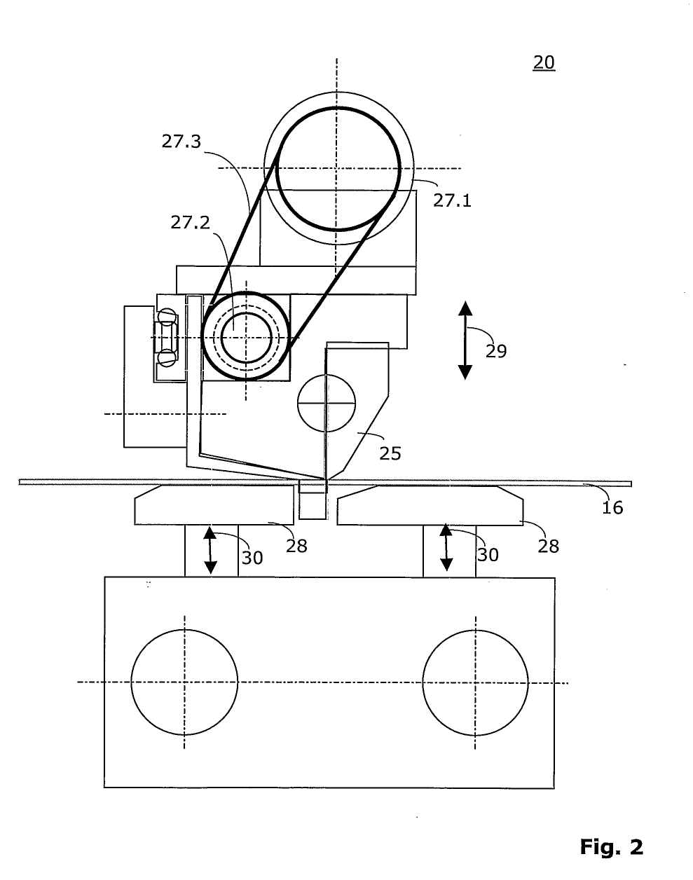

In addition, the nozzle seat 20 is preferably adjustable about an angle W, when the pitch angle W is between 0 and 20 degrees, preferably between 2 and 10 degrees, as indicated in the highly schematic plan view in FIGS. 3A and 3B. Also the nozzle 15 in FIG. 1 can be designed correspondingly adjustable.

In the highly schematic plan view in FIGS. 3A and 3B, a further embodiment is shown. In the shown embodiment, the nozzle 35 can be adjusted, as optionally also in FIG. 1 and FIG. 2. In FIG. 3A the angle W of the nozzle 35 with respect to the rib course is zero degrees and the discharge opening 35.1 of the nozzle 35 extends therefore parallel to the ribs of the corrugated cardboard 16. In FIG. 3B, the angle W is greater than zero degrees and the discharge opening 35.1 of the nozzle 35 extends obliquely to the ribs of the corrugated cardboard 16. The oblique adjustment has the advantage that the nozzle 35 is always, viewed over its entire length, in contact with at least one shaft, when the device is operated in the contact mode. In this case, the nozzle 35 combs obliquely over the ribs of the corrugated cardboard 16.

The devices according to the invention can, depending on need, be operated in two different operating modes (contactless mode and contact mode). Either an embodiment can be designed so that it can be switched from one mode into the other, or the embodiment can be designed especially for one of the two modes.

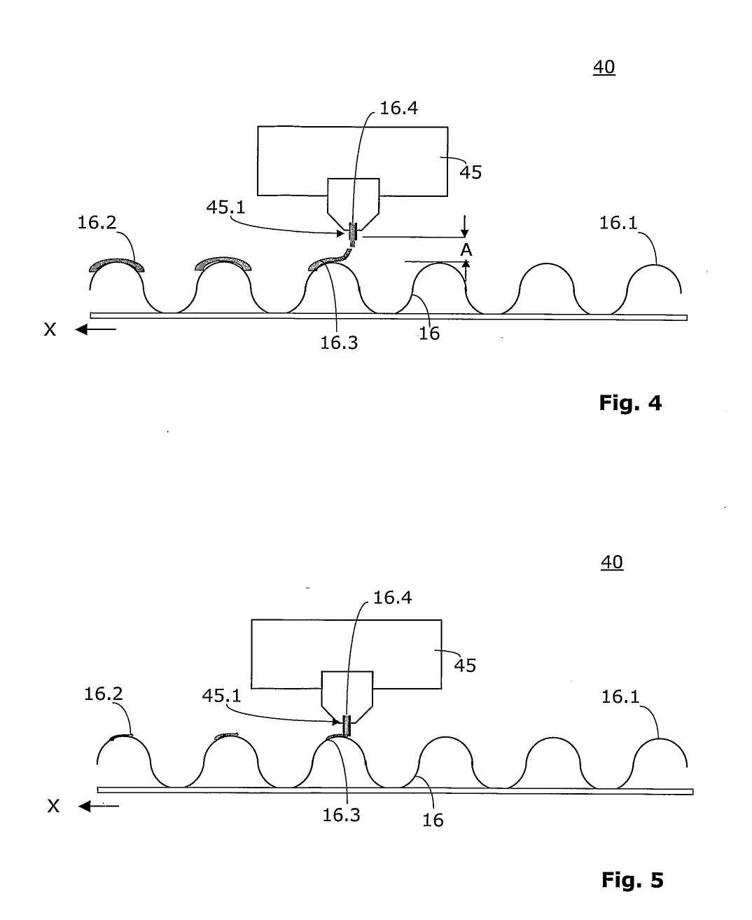

In the first mode (contactless mode), which is shown in FIG. 4, a type of intermittent adhesive application is produced in that the discharge opening 45.1 of the nozzle 45 is arranged at a spacing A so closely over the ribs 16.1 that a continuously discharging adhesive film 16.4 in each case briefly breaks away and therefore only covers the uppermost regions of the ribs 16.1 with adhesive 16.2. In FIG. 4, a moment is shown, in which the adhesive film 16.4 is just breaking away, after an adhesive strip 16.3 has been applied to a rib. In this mode, the angle W is preferably adjusted to zero degrees or to an angle of less than 5 degrees.

The second mode (contact mode) is shown in FIG. 5. In this mode, a type of intermittent adhesive application is produced in that the discharge opening 45.1 of the nozzle 45 sweeps at a spacing A=0 over the ribs 16.1 of the corrugated cardboard 16. An adhesive film 16.4 is continuously discharged by the nozzle 45. As the corrugated cardboard 16 moves relative to the nozzle to the left, as indicated by the arrow X, the adhesive film 16.4 is in each case removed or separated off by the contact or approach of the discharge opening 45.1 to the uppermost region of the rib 16.1. It is to be seen in FIG. 5 that the adhesive precipitates on the ribs 16.1 comes out slightly shorter and thinner than in the first mode, wherein this depends, however, on the adjustments (feed speed, adhesive quantity/time unit, viscosity of the adhesive, form and character of the corrugated cardboard, etc.). In FIG. 5, an adhesive strip 16.3 is just being produced by the breaking away of the adhesive film 16.4. In this mode, the angle W is preferably adjusted greater than zero degrees, wherein the angle W is preferably between 2 and 10 degrees.

A device according to the invention can be equipped with various control and checking members, to be able to monitor the method according to the invention.

In a preferred arrangement, parallel to the nozzle, an ionising rod or the like is arranged so as to be able to influence/deflect the adhesive film 16.4 after leaving the discharge opening 45.1. By suitable charging of the ionising rod, for example, the adhesive film 16.4 can be tensioned and therefore influenced.

The nozzles can, according to the invention, have cleaning lips or other cleaning elements. These lips or elements can be used to clean the nozzles, as contaminations can occur from the inside (owing to size) and from the outside (owing to parts of the cardboard). In the region of the discharge opening, lips may also be arranged, which allow a removal of the adhesive film on contact with or on approaching a rib. These lips may be flexible to prevent damage of the rib structure. These may also be follow-on lips, which are pulled over the ribs and in the process discharge the adhesive film. Preferably, inside the nozzle, a cleaning element is arranged which, by moving back and forth, prevents the development and/or settling of contaminations.

Preferably, the nozzle is a planar nozzle or a slot nozzle, which has an elongated discharge opening. The nozzle is preferably arranged in such a way that over the entire length L (see FIG. 3B) of the discharge opening, the spacing A from the corrugated cardboard 16 is substantially the same.

As described further above, the nozzle may preferably be adjusted obliquely with respect to the course of the ribs 16.1. As a consequence, the adhesive is removed obliquely and the nozzle is located always at least at one point on the corrugated cardboard. As a consequence, oscillations in the contact mode are reduced. The device therefore operates more quietly and the mechanical stress of the device is less.

In the devices according to the invention, the corrugated cardboard 16 can either be moved as a corrugated cardboard web or in the form of individual corrugated cardboard sheets past the nozzle. It is also conceivable to move the nozzle past the corrugated cardboard 16.

In a further embodiment, the device comprises means to apply on the ribs 16.1 provided with adhesive, liner paper or liner cardboard, in order to thereby produce a sandwich structure.

Preferably, the device is implemented such that a closed adhesive course is produced, in which adhesive penetrates to the outside only in the region of the nozzle.

In a preferred embodiment, a nozzle is used, which is self-cleaning. The self-cleaning nozzle may, for example, have a cleaning lip, cleaning elements or the like, as described.

Preferred is an embodiment, in which the nozzle carries out an oscillating transverse movement, which is substantially directed in the extension direction of the discharge opening. By this transverse movement it is prevented that, from outside, contaminants settle on the nozzle.

The spacing A can, according to the invention and depending on the embodiment, be adjusted manually or by motor.

The device according to the invention may preferably be designed with means for intermittent adhesive application, wherein the means preferably have a controlled lip or a controlled slide, in order to interrupt the adhesive film, which discharges at the discharge opening or to influence the discharging adhesive quantity. Preferably, this influencing takes place synchronously with the ribs of the corrugated cardboard moving past. A synchronisation of this type can take place by visual scanning of the corrugated cardboard.

Preferably, the device has an adhesive distributor in order to introduce the adhesive uniformly (with respect to the length L) into the nozzle.

Depending on the embodiment, with the present invention, an adhesive application quantity between 5 g/m² and 20 g/m² can be achieved. Preferably, the adhesive discharge quantity is adjusted between 8 g/m² and 14 g/m².

Depending on the embodiment, with the present invention, the corrugated cardboard can be moved at a speed between 100 m/min and 300 m/min, preferably at a speed between 120 m/min and 180 m/min, past the nozzle.

In a preferred embodiment, a standstill pressure of the adhesive in the nozzle is predetermined, in order to be able to immediately discharge, after the approach of the device, adhesive in the desired quantity. By a measure of this type, the device can be stopped at any time, in order to then start up again. The waste is thereby substantially reduced.

Preferably, the device is provided with an automatic thickness adjustment in order to bring the nozzle, depending on the thickness of the corrugated cardboard to a predetermined spacing A.

1. Device (10; 20; 30; 40) for applying adhesive (16.4) to the ribbed side (16.1) of corrugated cardboard (16) in order to apply on the ribs (16.1) provided with adhesive (16.2, 16.3) liner paper or liner cardboard and thus to produce a sandwich structure, characterised in that the device (10; 20; 30; 40) comprises a slot nozzle (15; 25; 35; 45), which discharges liquid adhesive, while the ribbed side (16.1) of the corrugated cardboard (16) is moved past at a spacing (A) below the slot nozzle (15; 25; 35; 45), wherein the spacing (A) is adjustable in such a way that when the corrugated cardboard (16) moves past, a slight contact is produced between the slot nozzles (15; 25; 35; 45) and the ribs (16.1) and owing to this interaction only in the upper region of the ribs (16.1), adhesive is applied on the ribbed side, and the slot nozzle (15; 25; 35; 45) is adjusted obliquely with respect to the course of the ribs (16.1).

2. Device (10; 20; 30; 40) according to claim 1, characterised in that the slot nozzle (15; 25; 35; 45) is a planar nozzle, which has an elongated discharge opening (15.1; 35.1; 45.1), wherein the slot nozzle (15; 25; 35; 45) is arranged in such a way that over the entire length (L) of the discharge opening (15.1; 35.1; 45.1) the spacing (A) from the corrugated cardboard (16) is substantially the same.

3. Device (10; 20; 30; 40) according to claim 1, characterised in that the device (10; 20; 30; 40) comprises a pump (12) and an adhesive reservoir (11) in order to convey, during the application, adhesive continuously from the reservoir (11) into the slot nozzle (15; 25; 35; 45) and to discharge it from there as a continuous adhesive film (16.4).

4. Device (10; 20; 30; 40) according to claim 1, characterised in that the corrugated cardboard (16) is moved in the form of individual corrugated cardboard sheets past the slot nozzle (15; 25; 35; 45).

5. Device (10; 20; 30; 40) according to claim 1, characterised in that the slot nozzle carries out an oscillating transverse movement.

6. Device (10; 20; 30; 40) according to claim 1, characterised in that the slot nozzle (15; 25; 35; 45) is a self-cleaning slot nozzle (15; 25; 35; 45).

7. Device (10; 20; 30; 40) according to claim 1, characterised in that the spacing (A) can be adjusted manually or by motor.

8. Device (10; 20; 30; 40) according to claim 1, characterised in that the nozzle (15; 25; 35; 45) is designed with means for intermittent adhesive application, wherein the means optionally have a controlled lip or a controlled slide.

9. Device (10; 20; 30; 40) according to claim 1, characterised in that the device (10; 20; 30; 40) comprises an adhesive distributor, to introduce the adhesive uniformly into the slot nozzle (15; 25; 35; 45).

10. Device (10; 20; 30; 40) according to claim 1, characterised in that the device (10; 20; 30; 40) has a through-flow measurement and regulation (13, 14) in order to be able to influence the adhesive application.

11. Device (10; 20; 30; 40) according to claim 1, characterised in that the device (10; 20; 30; 40) is designed such that an adhesive application quantity on each corrugation all-over and between 5 g/m² and 20 g/m² is achievable, and optionally between 8 g/m² and 14 g/m².

12. Device (10; 20; 30; 40) according to claim 1, characterised in that the device (10; 20; 30; 40) is designed such that the corrugated cardboard (16) is moved at a speed between 100 m/min and 300 m/min, optionally at a speed between 120 m/min and 180 m/min, past the slot nozzle (15; 25; 35; 45).

13. Device according to claim 1, characterised in that the device (10; 20; 30; 40) comprises an automatic thickness adjustment to bring the slot nozzle (15; 25; 35; 45) depending on the thickness of the corrugated cardboard (16) into a predetermined spacing (A).

14. Method for applying an adhesive on the ribs (16.1) of corrugated cardboard (16) with the following steps:
adjusting a spacing (A) between a discharge opening (15.1; 35.1; 45.1) of a slot nozzle (15; 25; 35; 45) and the ribs (16.1) of the corrugated cardboard (16),
generating a relative movement between the corrugated cardboard (16) and the slot nozzle (15; 25; 35; 45), wherein a slight contact is produced between the slot nozzles (15; 25; 35; 45) and the ribs (16.1).
conveying an adhesive into the nozzle (15; 25; 35; 45), wherein through the discharge opening (15.1; 35.1; 45.1) of the slot nozzle (15; 25; 35; 45) an adhesive film (16.4) is discharged,
adjusting the speed of the relative movement and the spacing (A), in order to make possible an adhesive application only on the upper regions of the ribs (16.1).

15. The method according to claim 14, characterised in that additionally a pitch angle (W) is also adjusted and the slot nozzle (15; 25; 35; 45) is thereby adjusted obliquely with respect to the course of the ribs (16.1).

16. The method according to claim 14, characterised in that when adjusting a spacing (A) an acoustic check takes place in order to recognise, whether the slot nozzle (15; 25; 35; 45) touches the ribs (16.1) of the corrugated cardboard (16).
